(19) United States
(12) Patent Application Publication
(10) Pub. No.: US 2011/0073729 A1
(43) Pub. Date: Mar. 31, 2011

(54) LADDER STORAGE DEVICE

(76) Inventor: Bruce Lawrence DeSautel, Miami, FL (US)

(21) Appl. No.: 12/571,126

(22) Filed: Sep. 30, 2009

(51) Int. Cl. A47B 96/06; F16M 13/00; E06C 1/00; E06C 1/02

(52) U.S. Cl. 248/217.4; 248/343; 248/220.21; 182/194; 182/207

(57) ABSTRACT

A ladder storage device includes: a ladder end cradle, adapted to releasably, rotatably receive the top end of the ladder when the ladder is in an lowered orientation. When the ladder is received and rotated into a raised orientation, the ladder end cradle retains the top end of the ladder so that the legs of the ladder may be releasably held to the ceiling, thereby storing the ladder adjacent to the ceiling.

### BACKGROUND OF THE INVENTION

The present invention generally relates to storage devices, and more specifically, to a ladder storage device.

There is nothing currently available that lays flat to the ceiling. The current storage devices are either L-brackets or hooks that let the ladder hang from one side or two people are needed to lift the ladder to the storage area. Two people are needed because the unit cannot be pivoted in place. It has to be placed flat in one motion.

As can be seen, there is a need for a ladder storage device that secures A-Frame and extension ladders flush to the ceiling of a garage or storage area.

### SUMMARY OF THE INVENTION

In one aspect of the present invention, a device for a storing a ladder adjacent to a ceiling, the ladder having a top end and legs, includes: a ladder end cradle, adapted to releasably, rotatably receive the top end of the ladder when the ladder is in an lowered orientation; wherein, when the ladder is received and rotated into a raised orientation, the ladder end cradle retains the top end of the ladder so that the legs of the ladder may be releasably held to the ceiling, thereby storing the ladder adjacent to the ceiling.

In another aspect of the present invention, a method for storing a ladder adjacent to a ceiling includes: orienting the ladder in an angled positioned; receiving a top end of the ladder into a ladder end cradle attached to the ceiling; rotating the ladder about its top end into an orientation generally adjacent to the ceiling; securing the legs of the ladder adjacent to the ceiling; and supporting the ladder, thereby storing the ladder adjacent to the ceiling.

These and other features, aspects and advantages of the present invention will become better understood with reference to the following drawings, description and claims.

### BRIEF DESCRIPTION OF THE DRAWINGS

FIG. 1 depicts an embodiment of the present invention, utilizing an A-frame ladder;

FIG. 2 depicts a side view of an embodiment of the present invention;

FIG. 3 depicts a perspective view of an embodiment of the present invention;

FIG. 4 depicts an embodiment of the present invention in the stored orientation;

FIG. 5 depicts an embodiment of the present invention, utilizing an extension ladder;

FIG. 6 depicts a side view of an embodiment of the present invention; and

FIG. 7 depicts a perspective view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a ladder storage device that secures A-Frame and extension ladders flush to the ceiling of garage or storage area.

An embodiment of this device permits the storage of a ladder flat against the ceiling.

An embodiment of the present invention includes a bracket that accepts the head of the ladder so the body can be pivoted up to a resting position against the ceiling. The ladder is then held up by straps on the non pivoting side.

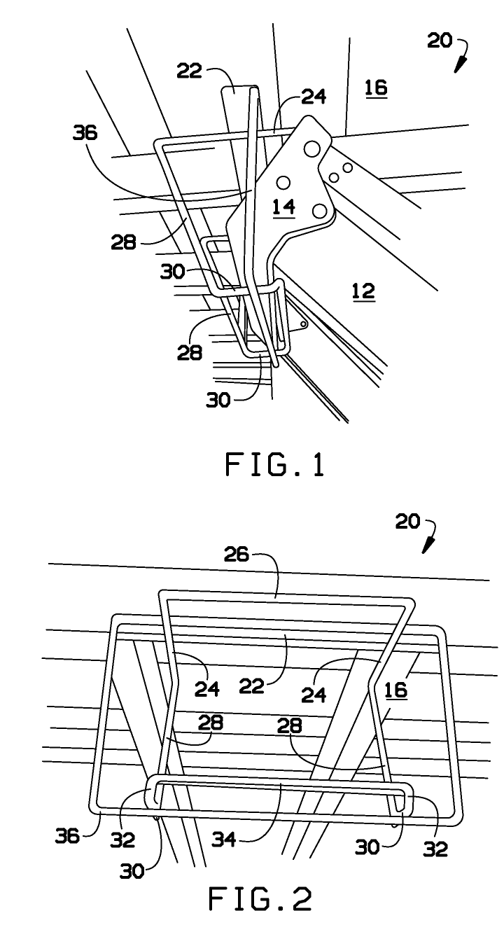

As depicted in FIGS. 1, 2, and 3, an embodiment of the present invention may be utilized with an A-frame ladder. It includes a ladder end cradle 20 that accepts the head 14 of an A-frame ladder 12. The ladder end cradle 20 may be made from either steel or plastic. The ladder end cradle 20 has a mounting plate 22 that attaches to the ceiling 16. Mounting plate 22 may be approximately 14.5″ long and 2″ wide. Attached to mounting plate 22 are two horizontal top bars 24 that are perpendicular to the axis of mounting plate 22, and parallel to the plane of the mounting plate 22 and the ceiling 16. The top bars 24 are approximately 10.5″ apart and recessed in from the edges of mounting plate 22 by approximately 2″. The top bars 24 extend forward of the mounting plate 22 approximately 2.5″ and behind the plate approximately 3.5″. A transverse top bar 26 connects the two top bars 24 together. The top bars 24 are angled downward from the ceiling 16 at approximately a 30 degree angle, to form two downward bars 28. This angle may coincide with the angle of the folded ladder head. The downward bars 28 are approximately 9″ long. At the lower end (closest to floor when mounted on ceiling) of the downward bars 28, the material is bent at approximately a 60 degree angle thus forming two bottom bars 30, which will be horizontal and parallel to the ceiling 16. The bottom bars 30 extend approximately 2.5″, and are then bent upward toward the ceiling at approximately a 90 degree angle to form two upward bars 32. The upward bars 32 extend approximately 1″. A double welded retaining lip 34 is attached to the ends of the upward bars 32, thus tying the two halves of the ladder end cradle 20 together so that it can receive and retain the head 14 of the ladder 12.

A stabilizing hoop 36 is attached to the mounting plate 22 that extends parallel to the mounting plate 22, turns downward at the outside edges of the plate, and extends downward toward the bottom of the bent bars and returning to meet underneath the embodiment 10. This creates a rectangular hoop 36 that keeps the ladder head 14 in place should it be hit. The stabilizing hoop 36 also centers the ladder head 14 in the embodiment 10 for ease of use.

As depicted in FIG. 4, the opposite side of the ladder 12 from the head 14 may be held securely to the ceiling 16 by several nylon/plastic snap clasp straps. The first strap 50 is placed around the center of the last rung 52 of the ladder 16. This strap 50 is closed when the ladder is first elevated to the resting position, and it can be secured with one hand because the receiving end of the strap 50 is locked into place. A second strap 54 reaches across the entire ladder from one side to the other as the final strap. This main strap 54 may be secured using both hands, after the first strap 50 is in place.

The A-frame embodiment of a ladder end cradle 20 forms a cage to hold the head 14 of the ladder 12. The cage does not need to move or rotate, because the upward bars 32 and retaining lip 34 engage with the ladder 12 to keep the ladder from sliding out. The ladder 12 is free to rotate about its head 14, so that it can be rotated by lifting or lowering the legs.

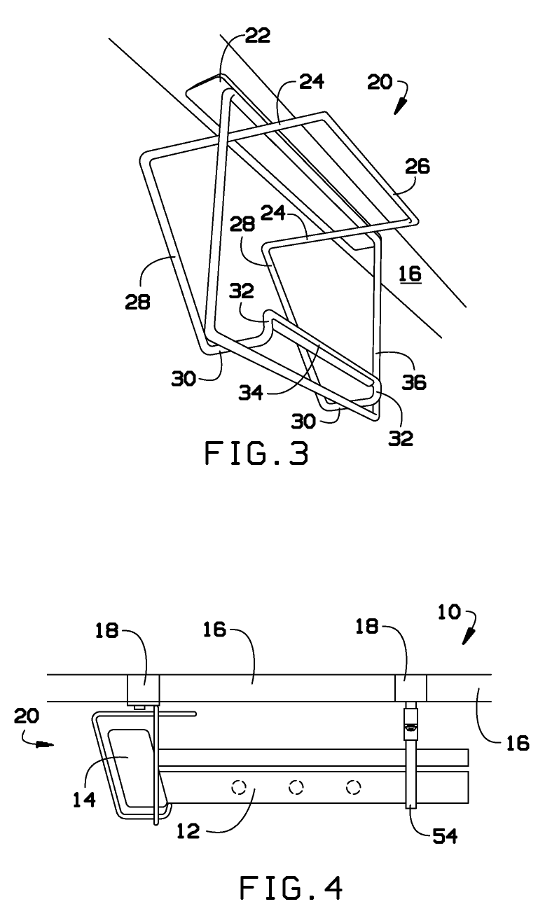

As depicted in FIG. 3, an embodiment may include additional lateral stabilizing bars that press against the ceiling to stabilize and give lateral support to the ladder end cradle.

If an embodiment of the receiving head is made of plastic/nylon, then an injection molding machine may make said invention. If the invention is made from round metal stock, then the pieces may be bent and welded together, to form a one piece head.

In an embodiment, the front edge (the part of the head of the ladder that faces you when it is opened to climb) of the ladder is placed in the ladder end cradle that is mounted to the ceiling with screws/bolts. The bottom of the ladder is resting on the ground or dangling downward if the ceiling is higher than the ladder is tall. The bottom part of the ladder is then swung up to the ceiling, holding said ladder in place with one hand, and the other hand secures the first strap around the last rung of the ladder. A secondary strap, located on the outside edges of the resting ladder legs, is then snapped closed to secure the ladder at rest against the ceiling.

To remove ladder, follow previous procedure backwards.

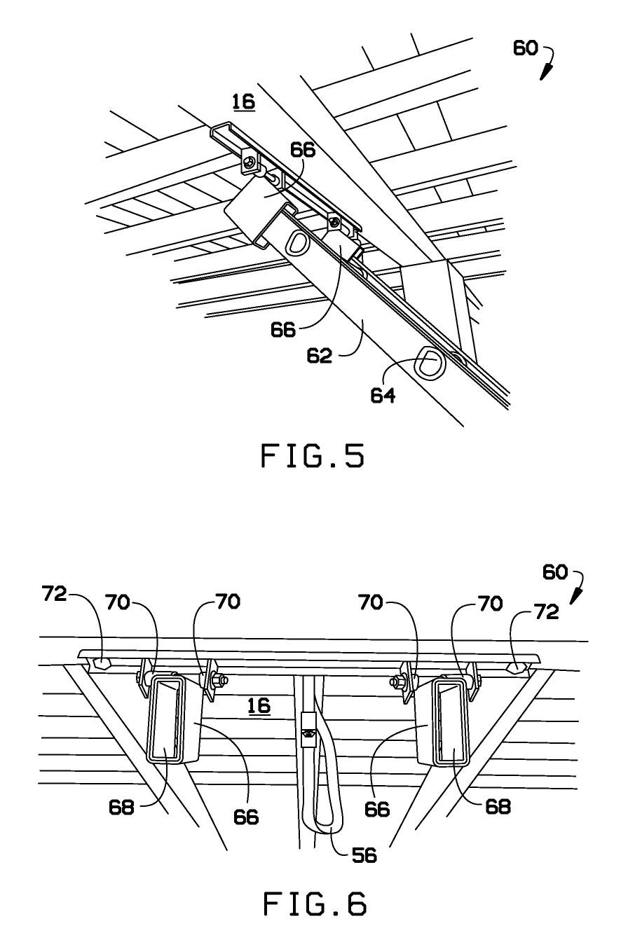

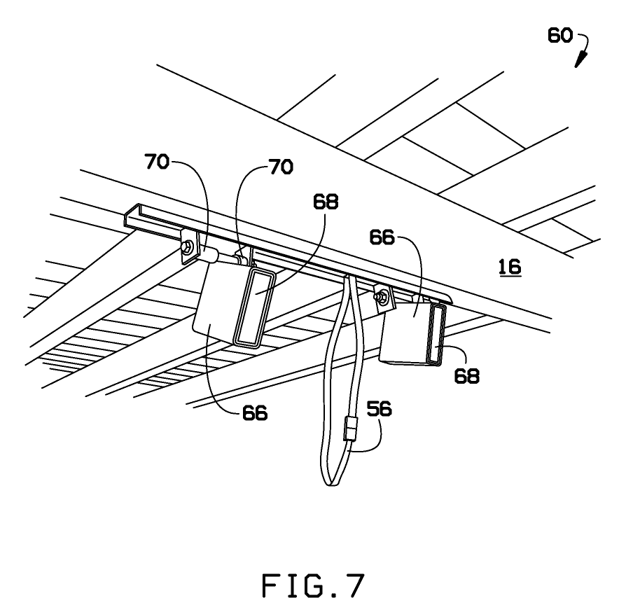

As depicted in FIGS. 5, 6, and 7, an embodiment of the present invention 10 includes a different ladder end retaining member or cradle 60 to accept an extension ladder 62. This ladder end cradle 60 would have two rectangular tubes 66 that the extension ladder legs 64 slide into. These tubes 66 could then be rotated upward, about hinges.

In another embodiment, a winch and pulley system could be applied at the base end of the ladder to raise and lower the ladder if necessary.

In an embodiment, the ladder is stored adjacent to the ceiling, in that the legs of the ladder are not necessarily in contact with or parallel to the ceiling, or even close to the ceiling, so long as a strap can be provided that is long enough to hang from the ceiling and tie to the ladder. In one embodiment, the ladder is held generally parallel to a flat ceiling.

In an embodiment, the device releasably, rotatably receives the ladder, in that it retains the top of the ladder (the head of an A-frame, or the legs of an extension ladder), and then the ladder can be rotated from a lowered, angled position into a raised, generally horizontal position for storage, and rotated back down to be released. In the raised orientation, the device retains and supports one end of the ladder.

An embodiment utilizing an A-frame ladder may have two straps, one in the center of the last rung and mounted to the ceiling. The receiving buckle is integrated into the mounting bracket and the strap comes down and encircles the bottom rung before being buckled. The tail can then be cinched tight to hold the ladder in place before the secondary strap is fastened. The secondary strap brackets are placed on the outside area of the ladder and will come from one side of the ladder to the other. It may buckle in the center of the ladder for ease of attachment and removal.

An embodiment utilizing an extension ladder may have the same strapping as for an A-frame ladder, with an additional security strap at the first rung of the ladder. This will hold the ladder tight to the receiver in case somebody pulls on the ladder. This may prevent the ladder from falling out of the receiver. The security strap may be mounted to the receiver itself. It will work the same as the first strap on the bottom side.

An embodiment utilizing extension ladder tubes may have bushings to better fit the different sizes of legs on extension ladders. The bushings may be made of plastic/nylon and sized to fit the ladder that is being stored. In addition, there may be several nylon bushings, which adjust the spread of the rectangular tubes to accept ladders of different widths.

It should be understood, of course, that the foregoing relates to exemplary embodiments of the invention and that modifications may be made without departing from the spirit and scope of the invention as set forth in the following claims.

We claim:

1. A device for a storing a ladder adjacent to a ceiling, the ladder having a top end and legs, the device comprising:
a ladder end cradle, adapted to releasably, rotatably receive the top end of the ladder when the ladder is in an lowered orientation;
wherein, when the ladder is received and rotated into a raised orientation, the ladder end cradle retains the top end of the ladder so that the legs of the ladder may be releasably held to the ceiling, thereby storing the ladder adjacent to the ceiling.

2. The device of claim 1, further comprising:
a strap to hold the legs of the ladder adjacent to the ceiling when the ladder is in the raised position.

3. The device of claim 1, further comprising:
a mounting plate, attached to the ladder end cradle; and
an attachment mechanism to attach the mounting plate to the ceiling.

4. The device of claim 1, further comprising:
a mounting plate, attached to the ladder end cradle; and
a plurality of mounting screws to attach the mounting plate to the ceiling, each mounting screw having a handle for a user to screw the mounting screw into the ceiling.

5. The device of claim 1, the ceiling having a beam, the device further comprising:
a mounting plate, attached to the ladder end cradle;
an attachment mechanism to attach the mounting plate to a lower surface of the beam; and
a stabilizing hoop to brace the ladder end cradle against a side surface of the beam.

6. The device of claim 1, the ladder being an A-frame ladder having a head, the ladder end cradle further comprising:
a cage, attached to the mounting plate, adapted to receive and support the head of the ladder; and
a lip on the cage that releasably engages with the head of the ladder so as to allow the ladder to be rotated about its head.

7. The device of claim 1, the ladder being an extension ladder having a leg, the ladder end cradle further comprising:
a tube adapted to receive and support the leg of the ladder, the tube rotatably attached to the mounting plate so as to allow the ladder to be rotated between the raised orientation and the lowered orientation.

8. The device of claim 1, the ladder being an extension ladder having first and second legs, the ladder end cradle further comprising:
a first, generally rectangular tube adapted to receive and support the first leg of the ladder; and
a second, generally rectangular tube adapted to receive and support the second leg of the ladder;
wherein the first and second tubes are rotatably attached to the mounting plate so as to allow the ladder to be rotated between the raised orientation and the lowered orientation.

9. A method for storing a ladder adjacent to a ceiling, comprising:
orienting the ladder in an angled positioned;
receiving a top end of the ladder into a ladder end cradle attached to the ceiling;
rotating the ladder about its top end into an orientation generally adjacent to the ceiling;
securing the legs of the ladder adjacent to the ceiling; and
supporting the ladder, thereby storing the ladder adjacent to the ceiling.

10. The method of claim 9, further comprising:
providing a mounting plate attached to the ladder end cradle;
attaching the mounting plate to a first portion of the ceiling; and
providing a stabilizing hoop, attached to the mounting plate, to press against a second portion of the ceiling so as to stabilize the ladder end cradle.
